(19) United States
(12) Patent Application Publication
(10) Pub. No.: US 2019/0175453 A1
(43) Pub. Date: Jun. 13, 2019

(54) A LID FOR A DRINKING BOTTLE

(71) Applicant: Herobility AB, Västeräs (SE)

(72) Inventor: Mikael Bergström, Västeräs (SE)

(21) Appl. No.: 16/307,720

(22) PCT Filed: Jun. 7, 2016
(86) PCT No.: PCT/SE2016/050542

§ 371 Date: Dec. 6, 2018

(51) Int. Cl. A61J 11/00; A61J 11/04; A61J 9/00

(52) U.S. Cl. CPC A61J 11/0035; A61J 9/00; A61J 11/04

(57) ABSTRACT

The present invention relates to a lid (1) configured to be attached to a fluid container of a drinking bottle. The lid (1) comprises a body (5), and a spout (6) protruding from the body (5) and having a discharge opening (7) at a top portion (8) thereof. The body (5) is provided with a recess (10a-b) extending along a part of a transition (11) between the body (5) and the spout (6). The recess (10a-b) is configured to receive a portion of the lip of a user when the user drinks from the drinking bottle so as to make a spout remote elevation (14a-b) of said recess (10a-b) to bear against lip adjacent portions of the cheek of the user to thereby seal the lip portion received in said recess (10a-b) with respect to the environment. The invention also relates to a baby bottle provided with such a lid (1).

### TECHNICAL FIELD OF THE INVENTION

The present invention relates to a lid configured to be attached to a fluid container of a drinking bottle according to the preamble of claim 1.

The invention relates to such a lid of any conceivable type, which may be attached to for instance a sport water bottle or a hiking bottle, but a lid for a baby bottle for babies and toddlers may be mentioned as a typical example without restricting the invention thereto.

Such a lid is used to close a top opening of a fluid container of the drinking bottle and to allow a user to drink the fluid through the discharge opening of the lid. It is preferred that the user's mouth is properly sealed to the body of the lid during drinking, so that no fluid is spilled from the mouth and for instance makes the user's clothes dirty. This is especially important by a baby bottle as a baby does not have as good drinking technique as an adult.

### BACKGROUND ART

A lid of the type defined in the introduction is already known through the document US 2006/0011572 A1. Said document discloses a lid (10) for a baby bottle, with a body (40) provided with a spout (20) with a discharge opening (15) (see for instance the FIGS. 1 and 2). The body of the lid is further provided with bilateral extensions (100) each configured to be arranged in a respective corner of the mouth of the user (infant or baby) during drinking from the bottle, to thereby occlude a gap formed between conventional nipples and the corner of the baby's mouth and consequently prevent air-intake through said gap during drinking.

A common problem of drinking bottles, especially baby bottles, already known, through for instance said document, is that fluid tends to leak out from the mouth of the user, usually through the corners of the mouth as a baby's oral musculature is insufficiently developed to force the mouth shape into exact compliance to the spout for a period of time sufficient to complete feeding. Even though the gaps of the corners of the mouth are occluded by the extensions of the lid disclosed in said document, these will not prevent fluid from leaking out from the corners of the mouth. Perhaps they may even have the opposite effect, as they form a respective guiding path along which the fluid may seep out of the mouth.

In the light of this problem, as one example, there is a need for a lid configured to be attached to a fluid container of a drinking bottle which is designed to be more suitable for the use thereof, for instance to prevent leakage of fluid from the mouth during drinking.

### SUMMARY OF THE INVENTION

The object of the present invention is to provide a lid configured to be attached to a fluid container of a drinking bottle of the type defined in the introduction being improved in at least some aspect with respect to such lids already known.

This object is according to the invention obtained by providing such a lid with a body provided with at least one recess extending along at least a part of a transition between the body and the base portion of the spout and configured to receive at least a portion of the lip of the user when the user drinks from the drinking bottle, so as to make a spout remote elevation of said recess to bear against lip adjacent portions of the cheek of the user to thereby seal the lip portion received in said recess with respect to the environment.

When the user of the drinking bottle, such as a baby, places the lips around the spout to start drinking from the bottle the lips are received in said at least one recess and sealed from the environment therein so that no leakage of fluid from the mouth will occur during drinking, at least not from where the lips are received in the at least one recess. This is ensured by the spout remote elevation of said recess bearing against lip adjacent portions of the cheek from the outside of the mouth so that the lip portion is properly sealed. A lid according to the invention provides a more convenient and less sloppy drinking for the user in comparison with the use of lids of this type already known.

According to an embodiment of the invention one or more said recesses extend along at least two opposing side sections of the transition so as to allow at least the lip portions of the two corners of the user's mouth to be received therein when the user drinks from the drinking bottle. The corners of the mouth are probably the most critical locations when it comes to fluid leakage, i.e. where it is most common that leakage occurs. By sealing these two portions of the mouth by means of the one or more recesses, and more particularly by the spout remote elevation thereof, the leakage of fluid from the mouth during drinking is effectively counteracted.

According to another embodiment of the invention one or more said recesses extend along at least 50%, preferably at least 70%, more preferred 100%, of the circumference of the transition around the base portion of the spout. The more of the circumference of the transition around the base portion of the spout provided with a said recess or recesses the greater part of the mouth/lips will be sealed against the environment. With 100% extension of a said recess along the circumference around the base portion of the spout the mouth is optimally sealed against the body of the lid and the risk of leakage minimized.

According to another embodiment of the invention the at least one recess has a width, measured in the direction between the spout and an outer circumferential edge of the lid, selected to have the lip portion of the user received therein wedged and thereby removably secured between opposite elevations defining said recess. When the at least one lip portion of the user is wedged between opposite elevations defining a said recess potential leakage of fluid is effectively counteracted, as the path of the fluid out of the mouth is blocked both between the spout adjacent elevation of the recess and the inside of the lip and also between the outer side of the lip and the spout remote elevation of the recess.

According to another embodiment of the invention surfaces of the at least one recess are provided with a friction enhancing layer. The friction enhancing layer implies a good grip of the user's lips against the body in the at least one recess and thereby that the lips are well secured in the recess when the user drinks from the drinking bottle.

According to another embodiment of the invention a surface region of the body surrounding the spout is provided with a friction enhancing layer. The region provided with a friction enhancing layer implies a good grip of the user's lips against the body around the complete circumference of the base portion of the spout. This means that the user has a good ability to tightly encircle the spout with his lips.

According to another embodiment of the invention the body is provided with at least one protrusion located at the opposite side of the at least one recess with respect to the spout and configured to bear against a user's cheek when the at least one lip portion of the user is received in the at least one recess of the body so as to act as a support for the cheek and thereby counteract that the spout slides away from a proper central position in the mouth when the user drinks from the drinking bottle.

According to another embodiment of the invention the body is provided with at least two said protrusions arranged at opposite sides of the spout so as to wedge the user's cheeks therebetween when the at least one lip portion of the user is received in the at least one recess. A body provided with two said protrusions enables excellent attachment of the mouth around the spout which means that the bottle may be firmly held in a suitable position during drinking therefrom.

According to another embodiment of the invention the lid further comprises a circular attachment portion sealingly connected to an end of the body opposite to the spout and provided with means configured to secure the lid to the fluid container of the drinking bottle.

According to another embodiment of the invention the lid is configured to be attached to a fluid container of a baby bottle. A lid according to the invention is especially suitable to be used in combination with a baby bottle, by which there are high demands on the function of the lid, for instance the sealing thereof.

The invention also relates to a baby bottle provided with a lid according to the invention.

Further advantages as well as advantageous features of the invention will appear from the following description of an embodiment of the invention.

### BRIEF DESCRIPTION OF THE DRAWINGS

With reference to the appended drawings, below follows a specific description of an embodiment of the invention cited as an example.

In the drawings:

FIG. 1 is a perspective view of the front of a lid according to an embodiment of the invention,

FIG. 2 is a perspective view of the back of the lid of FIG. 1,

FIG. 3 is a perspective view of a side of the lid of FIG. 1,

FIG. 4 is a front view of the lid of FIG. 1,

FIG. 5 is a perspective view of the lid of FIG. 1 attached to a fluid container of a drinking bottle, and

FIG. 6 is a simplified sketch of a mouth of a baby imagined to be drinking through the lid of FIG. 1.

### DETAILED DESCRIPTION OF AN EMBODIMENT OF THE INVENTION

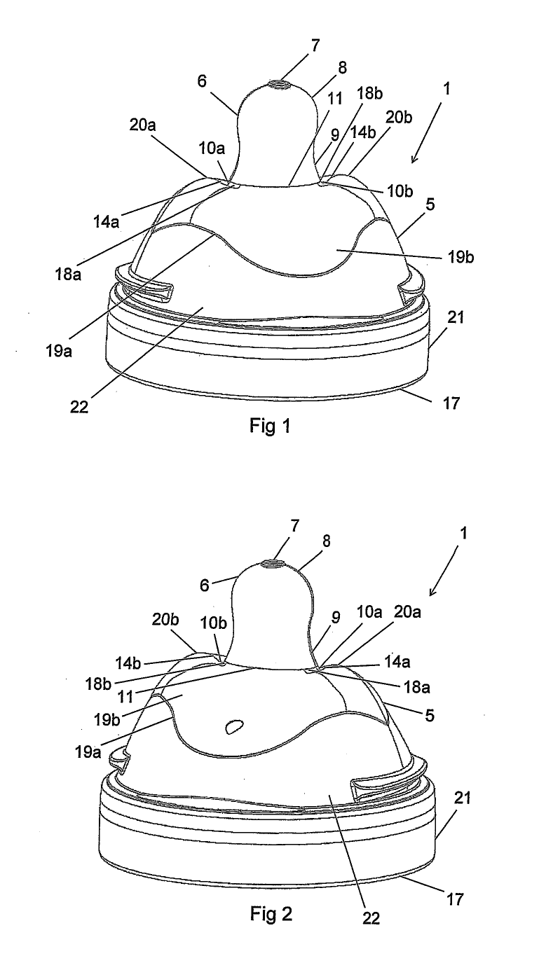

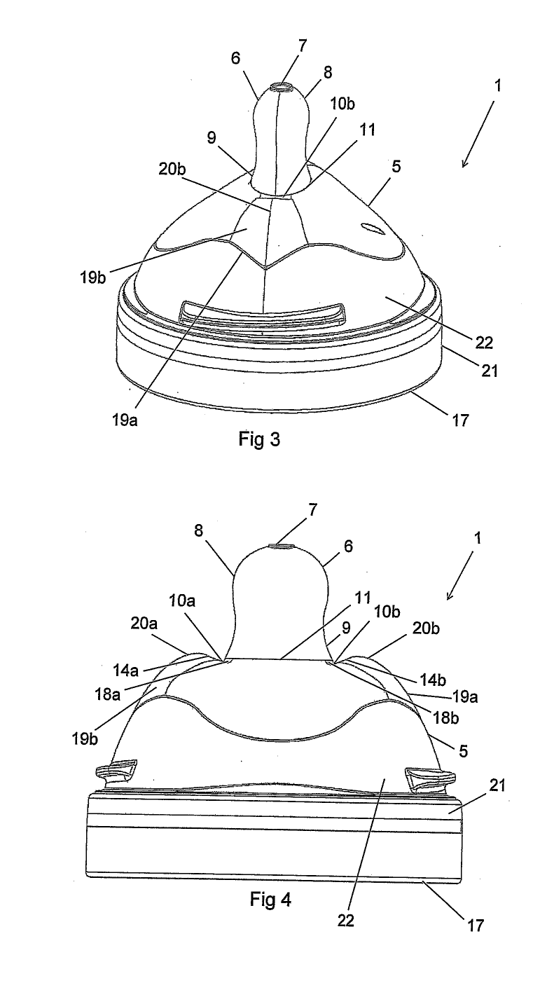

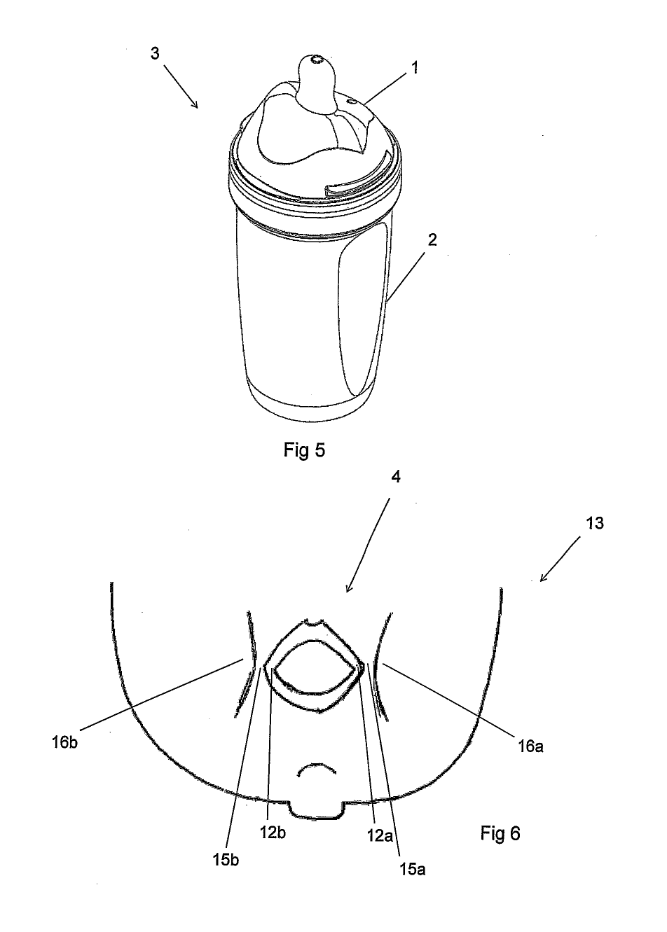

A lid 1 according to an embodiment of the invention is illustrated in the appended FIGS. 1-5 and will now be described while at the same time making reference to all these figures. The lid is configured to be attached to a fluid container 2 of a drinking bottle in the form of a baby bottle 3. FIG. 6 shows a mouth 4 of a baby imagined to be drinking from the baby bottle through the lid 1.

The lid 1 comprises a body 5 and a spout 6 protruding from the body and having a discharge opening 7 at a top portion 8 opposite to a base portion 9 of the spout connected to the body of the lid. The discharge opening is configured to enable a user, hereinafter baby 13, to drink the fluid contained in the fluid container 2 when the lid 1 is attached thereto.

The lid 1 further comprises a circular attachment portion 21 sealingly connected to an end 22 of the body 5 opposite to the spout 6 and provided with means configured to secure the lid to the fluid container 2 of the baby bottle 3. Said means are in this embodiment inner threads (not shown) configured to engage with outer threads around a top of the fluid container so as to secure the lid 1 thereto. The attachment portion 21 and the body 5 are preferably welded together, but may also be two separate parts assembled upon use of the bottle and disassembled upon washing thereof.

The body 5 and the spout 6 are made of an elastic material such as rubber or silicone to enable the baby to get a proper grip around the spout when drinking from the bottle 3, in the same way as of the breast of its mother. The circular attachment portion 21 is made of a rigid material, such as a hard plastic, to provide stability for the lid on the fluid container 2 of the bottle 3. It is also however possible to make the different parts out of other materials, such as to make a part of or the entire body 5 out of a hard plastic, and it is also possible that the same component comprises materials with different properties to obtain certain desired functions of the lid 1.

The body 5 of the lid 1 is provided with two recesses 10a-b extending along two respective opposing side sections of a transition 11 between the body 5 and the base portion 9 of the spout 6. Each recess 10a-b is configured to receive a lip portion 12a-b of a corner of a baby's 13 mouth 4 when the baby drinks from the baby bottle 3, so as to make a spout remote elevation 14a-b of the respective recess to bear against lip adjacent portions 15a-b of a cheek 16a-b of the baby to thereby seal the respective lip portion 12a-b received in said recess 10a-b from the outside of the mouth 4 with respect to the environment. The body 5 may have two or more, such as three, four, or even more said recesses together extending along a substantial part, such as at least 50%, at least 70% or 100% of the circumference of the transition 11 around the base portion 9 of the spout 6 or may have only one said recess 10a-b extending along a part of or the entire circumference of the transition around the base portion of the spout. In addition to the sealing of the lips said recesses also provide a comfortable grip portion for the baby's 13 lips around the spout 6 during drinking from the bottle 3.

The width of the recesses 10a-b, measured in the direction between the spout 6 and an outer circumferential edge 17 of the lid 1, is selected to have the lip portions 12a-b of the baby 13 received therein wedged and thereby removably secured between opposite elevations 14a-b, 18a-b defining the respective recess. This is achieved by the recesses being formed with one or more millimeters less in width than the average width of a baby's lips, such as between 3 and 5 millimeters halfway up in such a recess, so that the lips of the baby 13 are just slightly wedged and thereby secured in the recesses after being pushed down therein. This results in a steady and comfortable grip for the baby's mouth around the spout 6 during drinking as well as an effective sealing of the lips to the body of the lid.

The body 5 of the lid 1 further has a surface region 19a thereof surrounding the spout provided with a friction enhancing layer 19b which provides high friction between the surface of this region and the lips of the baby 13. The friction enhancing layer thereby provides a good ability for the baby to tightly encircle the spout 6 with the lips, as the surface of the layer provides a good grip for the baby's lips against this. That a friction enhancing layer provides “high friction” between two surfaces (here: the outer surface of the body and the lips of the baby) means that the coefficient of friction between these surfaces is higher with the friction enhancing layer arranged there between than without this. The high friction provided by the friction enhancing layer 19b may be obtained by this layer being formed by another material than for instance said connecting end 22 of the body 5, and/or by this layer having a rough surface, and/or is provided with a surface configuration such as grooves, dots or the like.

The friction enhancing layer 19b is especially suitable to use in combination with the recesses 10a-b, as it improves the function thereof by contributing to the securing of the baby's lips therein.

The body 5 of the lid 1 is additionally provided with two protrusions 20a-b, each located at the opposite side of a respective recess 10a-b with respect to the spout 6 and configured to bear against the baby's 13 cheek 16a-b when the respective lip portion 12a-b is received in the respective recess. The protrusions hereby act as supports for the cheeks and thereby counteract that the spout 6 slides away from a proper central position in the mouth 4 when the baby 13 drinks from the bottle 3. The protrusions are arranged at opposite sides of the spout 6 which furthermore make them wedge the baby's cheeks 16a-b between them when the lip portions 12a-b are received in the recesses 10a-b. The body of the lid may also be provided with more than two said protrusions 20a-b, such as three, four or even more said protrusions, or may be provided with only one said protrusion extending around the entire circumference of a said recess 10a-b extending around the entire circumference of the base portion 9 of the spout 6.

The invention is of course not in any way restricted to the embodiment thereof described above, but many possibilities to modifications thereof will be apparent to a person with ordinary skill in the art without departing from the scope of the invention as defined in the appended claims.

A lid configured to be attached to a fluid container of a drinking bottle is in this disclosure to be interpreted as a component securable to the fluid container to close an opening thereof and provided with an opening configured to allow a user to drink fluid contained in the fluid container when the lid is attached thereto. Such a lid may be securable to the fluid container by itself or may need to be used in combination with another component configured to secure the lid to the fluid container.

The wordings “baby bottle” and “baby” as used in this disclosure are not meant to restrict the invention to use by infants, but a baby bottle provided with a lid according to the invention may be used also by small children drinking gruel, as one example, such as children of 0-5 years of age or even older.

The recesses and the protrusions may be designed completely different from these as shown in the figures. A said recess is a recess with respect to a surrounding surface, which do not have to be a main surface of the body as in the example shown. A said recess may also be a recess in the top surface of a member protruding from the body of the lid, so that the bottom of the recess is located above the top surface of the body of the lid in height, just to mention one example.

1. A lid (1) configured to be attached to a fluid container (2) of a drinking bottle (3), comprising:
a body (5), and
a spout (6) protruding from the body (5) and having a discharge opening (7) at a top portion (8) opposite to a base portion (9) of the spout (6) connected to the body (5) of the lid (1), the discharge opening (7) being configured to enable a user (13) to drink the fluid contained in the fluid container (2) when the lid (1) is attached thereto,
wherein the body (5) is provided with at least one recess (10a-b) extending along at least a part of a transition (11) between the body (5) and the base portion (9) of the spout (6) and configured to receive at least a portion of the lip (12a-b) of the user (13) when the user (13) drinks from the drinking bottle (3), to make a spout remote elevation (14a-b) of said recess (10a-b) to bear against lip adjacent portions (15a-b) of the cheek (16a-b) of the user (13) to thereby seal the lip portion (12a-b) received in said recess (10a-b) with respect to the environment.

2. A lid (1) according to claim 1, wherein one or more said recesses (10a-b) extend along at least two opposing side sections of the transition (11) to allow at least the lip portions (12a-b) of the two corners of the user's (13) mouth (4) to be received therein when the user (13) drinks from the drinking bottle (3).

3. A lid (1) according to claim 1, wherein one or more said recesses (10a-b) extend along at least 50%, preferably at least 70%, more preferred 100%, of the circumference of the transition (11) around the base portion (9) of the spout (6).

4. A lid (1) according to claim 1, wherein the at least one recess (10a-b) has a width, measured in the direction between the spout (6) and an outer circumferential edge (17) of the lid (1), selected to have the lip portion (12a-b) of the user (13) received therein wedged and thereby removably secured between opposite elevations (14a-b, 18a-b) defining said recess (10a-b).

5. A lid (1) according to claim 1, wherein surfaces of the at least one recess (10a-b) are provided with a friction enhancing layer (19b).

6. A lid (1) according to claim 5, wherein a surface region (19a) of the body (5) surrounding the spout (6) is provided with a friction enhancing layer (19b).

7. A lid (1) according to claim 1, wherein the body (5) is provided with at least one protrusion (20a-b) located at the opposite side of the at least one recess (10a-b) with respect to the spout (6) and configured to bear against a user's (13) cheek (16a-b) when the at least one lip portion (12a-b) of the user (13) is received in the at least one recess (10a-b) of the body (5) to act as a support for the cheek (16a-b) and thereby counteract that the spout (6) slides away from a proper central position in the mouth (4) when the user (13) drinks from the drinking bottle (3).

8. A lid (1) according to claim 7, wherein the body (5) is provided with at least two said protrusions (20a-b) arranged at opposite sides of the spout (6) to wedge the user's (13) cheeks (16a-b) therebetween when the at least one lip portion (12a-b) of the user (13) is received in the at least one recess (10a-b).

9. A lid (1) according to claim 1, wherein the lid (1) further comprises a circular attachment portion (21) sealingly connected to an end (22) of the body (5) opposite to the spout (6) and provided with means configured to secure the lid (1) to the fluid container (2) of the drinking bottle (3).

10. A lid (1) according to claim 1, wherein the lid (1) is configured to be attached to a fluid container (2) of a baby bottle (3).

11. A baby bottle (3) provided with a lid (1) according to claim 1.

12. A lid (1) according to claim 2, wherein one or more said recesses (10a-b) extend along at least 50%, preferably at least 70%, more preferred 100%, of the circumference of the transition (11) around the base portion (9) of the spout (6).

13. A lid (1) according to claim 12, wherein the at least one recess (10a-b) has a width, measured in the direction between the spout (6) and an outer circumferential edge (17) of the lid (1), selected to have the lip portion (12a-b) of the user (13) received therein wedged and thereby removably secured between opposite elevations (14a-b, 18a-b) defining said recess (10a-b).

14. A lid (1) according to claim 3, wherein the at least one recess (10a-b) has a width, measured in the direction between the spout (6) and an outer circumferential edge (17) of the lid (1), selected to have the lip portion (12a-b) of the user (13) received therein wedged and thereby removably secured between opposite elevations (14a-b, 18a-b) defining said recess (10a-b).

15. A lid (1) according to claim 2, wherein the at least one recess (10a-b) has a width, measured in the direction between the spout (6) and an outer circumferential edge (17) of the lid (1), selected to have the lip portion (12a-b) of the user (13) received therein wedged and thereby removably secured between opposite elevations (14a-b, 18a-b) defining said recess (10a-b).

16. A lid (1) according to claim 15, wherein surfaces of the at least one recess (10a-b) are provided with a friction enhancing layer (19b).

17. A lid (1) according to claim 14, wherein surfaces of the at least one recess (10a-b) are provided with a friction enhancing layer (19b).

18. A lid (1) according to claim 13, wherein surfaces of the at least one recess (10a-b) are provided with a friction enhancing layer (19b).

19. A lid (1) according to claim 12, wherein surfaces of the at least one recess (10a-b) are provided with a friction enhancing layer (19b).

20. A lid (1) according to claim 4, wherein surfaces of the at least one recess (10a-b) are provided with a friction enhancing layer (19b).
